(19) United States
(12) Patent Application Publication
(10) Pub. No.: US 2026/0225827 A1
(43) Pub. Date: Aug. 6, 2026

(54) Container Treatment Plant Comprising Two Discharge Units

(71) Applicant: Krones AG, Neutraubling (DE)

(72) Inventors: Franz WEIGL, Pfakofen (DE); Carsten WIDERA, Aufhausen (DE)

(21) Appl. No.: 19/465,239

(22) Filed: Jan. 30, 2026

(30) Foreign Application Priority Data
Jan. 31, 2025 (DE) 102025103559.8

(51) Int. Cl. B65G 47/46; B65G 43/08

(52) U.S. Cl. CPC B65G 47/46; B65G 43/08; B65G 2201/0252; B65G 2203/0208

(57) ABSTRACT

A container treatment plant includes a transport apparatus for containers, two discharge units for discharging dimensionally unstable containers, such as cans, from the transport apparatus and at least one inspection apparatus. A first discharge unit of the two discharge units is configured for discharging containers that were treated using the container treatment plant and that have a defect, and a second discharge unit of the two discharge units is configured for discharging test containers that can be inserted into the container treatment plant for checking the functionality of the inspection apparatus.

### CROSS-REFERENCE TO RELATED APPLICATIONS

This application claims priority to, and the benefit of, German Patent Application No. 102025103559.8, filed January 31, 2025, the contents of which are incorporated by reference herein in their entirety.

### TECHNICAL FIELD

The present invention relates to a container treatment plant comprising a transport apparatus for containers, two discharge units and at least one inspection apparatus, and to a method for checking an operational capability of an inspection apparatus of a container treatment plant.

### BACKGROUND

Container treatment plants that comprise discharge units for containers are known from the prior art.

It is known to provide discharge units for discharging defective glass containers, PET containers, pulp containers, or cans, in particular beverage cans, from container treatment plants. The discharge units can be operated together with an inspection apparatus, wherein the inspection apparatus can recognize defects in the containers and the discharge unit can discharge the defective containers based on an inspection result of the inspection apparatus.

In order to check the functionality of the inspection apparatus, it is also known to drive test containers prepared having defects past the inspection apparatus and to check the functionality of the inspection apparatus using the test containers. The test containers are typically discharged from the container treatment plant by the same discharge apparatus that is also used for the above-described conventional containers. Due to the discharge with a conventional push apparatus, however, dimensionally unstable test containers, such as metal cans, in particular beverage cans or containers made of pulp, can be subjected to undesired damage during discharge. Since the test containers exhibit damage after being discharged, they can typically only be used once for checking an inspection apparatus. If the functionality of an inspection apparatus needs to be checked again, new test containers must be prepared. The containers and/or test containers are preferably empty, i.e., not filled with a liquid product.

### BRIEF SUMMARY

Aspects of the invention relate to a container treatment plant that enables a recurring and reliable check of the functionality of an inspection apparatus with the lowest possible consumption of test containers.

A container treatment plant according to one aspect of the invention comprises a transport apparatus for containers, two discharge units for discharging dimensionally unstable containers, such as cans, from the transport apparatus and at least one inspection apparatus, wherein a first discharge unit of the two discharge units is configured for discharging containers that were treated using the container treatment plant and that have a defect, and a second discharge unit of the two discharge units is configured for discharging test containers that can be inserted into the container treatment plant for checking the functionality of the inspection apparatus.

The transport apparatus can be any transport apparatus that is suitable for transporting containers. For example, the transport apparatus can be a linear transport apparatus, such as a conveyor belt, or can also be a rotary machine.

A dimensionally unstable container can be understood to mean a container whose shape can be changed by the application of external force without the container being destroyed. In particular, a dimensionally unstable container can be understood to mean a container whose shape is changed during discharge with the first discharge unit. Destroying the container can be understood to mean, for example, breaking the container into at least two parts. A dimensionally unstable container can be understood to mean, for example, a can or a container made of fiber-containing material. However, it can also be a container that contains a plastic and/or a metal and whose shape can be changed during discharge with the first discharge unit.

The treated containers can be treated, dimensionally unstable containers. The treated dimensionally unstable containers can, for example, be treated cans, such as cans containing a metal. However, it could also be treated containers made of fiber-containing material, plastic and/or metal.

The test containers can be dimensionally unstable. The dimensionally unstable test containers can be test cans, for example test cans comprising a metal. However, it could also be a test container made of fiber-containing material, plastic and/or metal.

For example, the transport apparatus can be a vacuum transport apparatus. The vacuum transport apparatus can be configured to apply a vacuum to the containers being transported on it, and in this way protecting them against tipping over.

The inspection apparatus can be configured for checking the containers for defects. A defect can be understood to mean, for example, damage to the container itself or contamination of the container itself. However, a defect can also be understood to mean a component that is incorrectly applied to the container or damaged, such as a label (EAN, country code), a printed image, a closure, a defective container flange, a dirty inner container wall, the recognition of (packaging) films in the container, a date-marking inspection, an inspection of the sliding coating of the container or any other component. The inspection apparatus can comprise at least one imaging sensor for checking the containers for defects, by means of which imaging sensor an image of the container can be taken. Containers treated using the container treatment plant can be understood to mean containers on which at least one treatment step has been performed using the container treatment plant or on which at least one treatment step is to be performed using the container treatment plant. A treatment step can be understood to mean, for example, manufacturing a container, cleaning a container, filling a container, printing on a container, labeling a container, closing a container or any other treatment step performed on the container which changes at least one property of the container.

A test container can be understood to mean a container specially prepared with a defect for checking the functionality of the inspection apparatus. The test containers can be provided solely for checking the functionality of the inspection apparatus. It can be provided that no treatment step is carried out on the test containers in the container treatment plant. The test containers can, for example, be equipped with at least one defined defect. After the inspection of the test container by the inspection apparatus, it can then be checked whether the at least one defined defect was correctly recognized by the inspection apparatus and in this way the functionality of the inspection apparatus can be checked.

The test containers can exhibit a marking that identifies them as test containers. Preferably, the marking is done using an optical code. The marking is particularly preferably carried out as a 2D code.

In another embodiment, the marking can be carried out using binary code or transponder.

The code preferably contains information about a (damage) type of the test container. A type of damage can be stored in the code, or, for example, a number that can be assigned in the central unit to a (test can) contamination type.

It is particularly desirable for the code to contain a dimension, a gray value or another characteristic of the test marking in order to prevent tampering with the test containers.

By providing two discharge units, defective containers and test containers treated by the container treatment plant can be discharged through differently configured discharge units. This ensures that test containers are discharged only by the designated second discharge unit, and that the second discharge unit is specifically configured for discharging test containers. The second discharge unit can, for example, be configured in such a way that it can discharge the test containers from the transport apparatus without damage. Since damage-free discharge of defective containers treated by the container treatment plant is not necessary, the first discharge unit can be conventionally configured. Due to the conventional configuration, a higher container throughput can be achieved during normal operation, preferably > 40,000 containers/h, and particularly preferably > 60,000 containers/h. By discharging the test containers without damage using the second discharge unit, the discharged test containers can be reused, which, on the one hand, saves resources and, on the other hand, creates comparable test conditions, since the same test containers can always be used for checking the functionality of the inspection apparatus.

In one embodiment, it can be provided that the first discharge unit is not active during a test operation of the container treatment plant and/or that the second discharge unit is not active during a normal operation of the container treatment plant. Normal operation can be understood to mean operation of the container treatment plant in which containers undergo at least one treatment step in the container treatment plant. A test operation can in turn be understood to mean an operation of the container treatment plant in which the functionality of the inspection apparatus is checked using a test container. By ensuring that the first discharge unit is not active during the test operation, it is possible to prevent test containers from being mistakenly discharged through the first discharge unit and thus damaged. Since the second discharge unit is not active during normal operation, it can be prevented that defective treated containers are mistakenly discharged through the second discharge unit. Furthermore, energy consumption can be reduced by switching off unneeded resources.

In a further development of the previous embodiment, it can be provided that the transport apparatus comprises a vacuum transport apparatus, wherein the vacuum transport apparatus is configured to apply a vacuum to the containers during normal operation and no vacuum during test operation. In this way, the energy consumption of the container treatment plant can be effectively reduced during test operation. Furthermore, a slight slippage of the test containers during test operation can be considered irrelevant, since it has no influence on the test operation and the discharge of the test containers through the second discharge unit.

Furthermore, it may be possible to operate the transport apparatus at a reduced transport speed during test operation compared to normal operation. For example, it can be provided that, during test operation with the transport apparatus, a container throughput of less than 40,000 cans/h, or of less than 20,000 cans/h is achieved. By reducing the transport speed during test operation, the speed of the test containers during discharge with the second discharge unit can be reduced, thus effectively preventing possible damage to the test containers during discharge.

It can be provided that the number of test containers inserted into the container treatment plant corresponds to the number of test containers discharged using the second discharge unit before the container treatment plant can be switched from test operation to normal operation. This prevents test containers from being located in the transport apparatus during normal operation.

Furthermore, it can be provided that the second discharge unit is arranged upstream of the first discharge unit with respect to a transport direction of the containers and/or the test containers. This ensures that the test containers initially pass through the second discharge unit and are discharged through it, thus preventing unwanted discharge of the test containers through the first discharge unit.

In one embodiment, it can be provided that the container treatment plant comprises a discharge control apparatus, wherein the discharge control apparatus is configured to check whether a container that was treated using the container treatment plant and that has a defect has been discharged by the first discharge unit, wherein the second discharge unit is arranged upstream of the discharge control apparatus with respect to a transport direction of the containers and/or the test containers. This ensures that the test containers are discharged from the second discharge unit before they pass the discharge control apparatus. In this way, it can be prevented that the test containers trigger an error signal of the discharge apparatus, which could, for example, lead to the entire container treatment plant being shut down.

It can further be provided that the second discharge unit comprises a discharge element that can be moved between a rest position and a discharge position, wherein the discharge element can be arranged next to the transport apparatus in the rest position and can be inserted into the transport apparatus in the discharge position, wherein, in the discharge position, a test container can be discharged from the transport apparatus along the discharge element or by a momentum transferred from the discharge element to the test container. Due to a correspondingly configured second discharge unit, reliable discharge of the test container from the transport apparatus can be achieved.

In a further development of the preceding embodiment, it can be provided that the second discharge unit comprises a test unit for checking the position of the discharge element. In this way, it can be ensured that the discharge element is located in the desired position, by which it is in turn ensured that the containers can be reliably discharged through the second discharge unit.

In one embodiment, it can be provided that the first and/or the second discharge unit comprises a storage apparatus for storing the discharged containers and/or test containers, wherein the second discharge unit optionally comprises a storage apparatus for the damage-free, orderly storage of the discharged test containers. By providing a storage apparatus, a larger number of containers and/or test containers can be discharged without interrupting the operation of the container treatment plant. Due to the optional damage-free storage of the test containers in the second storage apparatus, it can be ensured that the containers can be used multiple times for reliably checking the functionality of the inspection apparatus.

In one embodiment, it can be provided that the container treatment plant is configured to be operated during a test operation, wherein, during test operation, the containers treated by the container treatment plant can be driven out of the container treatment plant and at least one test container can be inserted into the container treatment plant for checking the functionality of the inspection apparatus. By providing a test operation in which no containers treated by the container treatment plant are located in the transport apparatus and a test container is inserted into the container treatment plant, the discharge of the test containers by the second discharge unit can be simplified, since it is not necessary to distinguish between test containers and defective treated containers.

According to another aspect of the invention, a method for checking the functionality of an inspection apparatus of a container treatment plant is further provided. The container treatment plant includes a transport apparatus for containers, two discharge units for discharging containers from the transport apparatus and at least one inspection apparatus. The method comprises, using a first discharge unit of the two discharge units, discharging, at least temporarily, containers that were treated using the container treatment plant and that have a defect and, using a second discharge unit of the two discharge units, discharging test containers that are inserted, at least temporarily, into the container treatment plant for checking the functionality of the inspection apparatus.

By providing two discharge units, defective containers and test containers treated by the container treatment plant can be discharged through differently configured discharge units. This ensures that test containers are discharged only by the designated second discharge unit, and that the second discharge unit is specifically configured for discharging test containers. The second discharge unit can, for example, be configured in such a way that it can discharge the test containers from the transport apparatus without damage. Since damage-free discharge of defective containers treated by the container treatment plant is not necessary, the first discharge unit can be conventionally configured. Due to the conventional configuration, a high container throughput can be achieved during normal operation. By discharging the test containers without damage using the second discharge unit, the discharged test containers can be reused, which, on the one hand, saves resources and, on the other hand, creates comparable test conditions, since the same test containers can always be used for checking the functionality of the inspection apparatus.

In one embodiment of the method, it can be provided that the first discharge unit is not active during a test operation of the container treatment plant and/or the second discharge unit is not active during a normal operation of the container treatment plant. By ensuring that the first discharge unit is not active during the test operation, it is possible to prevent test containers from being mistakenly discharged through the first discharge unit. Since the second discharge unit is not active during normal operation, it can be prevented that defective treated containers are mistakenly discharged through the second discharge unit. Furthermore, energy consumption can be reduced by switching off unneeded resources.

In a further development of the previous embodiment, the transport apparatus can comprise a vacuum transport apparatus, and a vacuum can be applied to the containers by the vacuum transport apparatus during normal operation and not applied during test operation.

In one embodiment, it can be provided that only test containers are conveyed on the transport apparatus during test operation. During test operation, the flow to containers that are not test containers can be stopped or held back by a blocking element.

In one embodiment, it can be provided that the test operation comprises the following steps: reducing the transport speed of the transport apparatus, stopping a flow of containers, for example by a blocking element, introducing at least one test container, passing the at least one test container through the inspection apparatus, discharging the at least one test container with the second discharge unit, and, if the test operation is successful, returning to normal operation.

Furthermore, it can be provided that the second discharge unit is arranged upstream of the first discharge unit with respect to a transport direction of the containers and/or the test containers. This ensures that the test containers initially pass through the second discharge unit and are discharged through the second discharge unit. This prevents unwanted discharge of the test containers through the first discharge unit.

In one embodiment, it can be provided that, during test operation, the transport speed of the transport apparatus is reduced, test containers are manually inserted into the container flow, and due to the low transport speed, the test containers can be discharged with less energy input. Alternatively, an apparatus can be used as a second discharge unit that, due to system design, does not cause any damage, but, at a certain production speed, does not make the discharge of the test cans possible with the desired reliability. Such a system could, for example, be a discharge system in which a discharge curve is composed of individual segments.

In one embodiment of the method, it can be provided that the container treatment plant comprises a discharge control apparatus, wherein the discharge control apparatus checks whether a container that was treated by the container treatment plant and that has a defect is discharged by the first discharge unit, wherein the second discharge unit is arranged upstream of the discharge control apparatus with respect to a transport direction of the containers and/or the test containers. This ensures that the test containers are discharged from the second discharge unit before they pass the discharge control apparatus. In this way, it can be prevented that the test containers trigger an error signal in the discharge control apparatus, which could, for example, lead to the entire container treatment plant being shut down. Furthermore, it can be provided that the second discharge unit comprises a discharge element that is moved at least temporarily between a rest position and a discharge position, wherein the discharge element is arranged next to the transport apparatus in the rest position and is inserted into the transport apparatus in the discharge position, wherein, in the discharge position, the test container is discharged from the transport apparatus along the discharge element or by a momentum transferred from the discharge element to the test container.

In a further development of the method according to the preceding embodiment, it can be provided that the second discharge unit comprises a test unit for checking the position of the discharge element. In this way, it can be ensured that the discharge element is located in the desired position, by which it is in turn ensured that the containers are reliably discharged through the second discharge unit.

In one embodiment of the method, it can be provided that the first and/or the second discharge unit comprises a storage apparatus for storing the discharged containers and/or test containers, wherein the second discharge unit optionally comprises a storage apparatus for the damage-free, orderly storage of the discharged test containers. By providing a storage apparatus, a larger number of containers and/or test containers can be discharged without interrupting the operation of the container treatment plant. Due to the optional storage of the test containers without damage in the second storage apparatus, it can be ensured that the containers can be used multiple times for reliably checking the functionality of the inspection apparatus.

### BRIEF DESCRIPTION OF THE DRAWING FIGURES

FIG. 1 shows a container treatment plant according to one embodiment.

FIG. 2a and FIG. 2b show a second discharge unit according to one embodiment.

### DETAILED DESCRIPTION

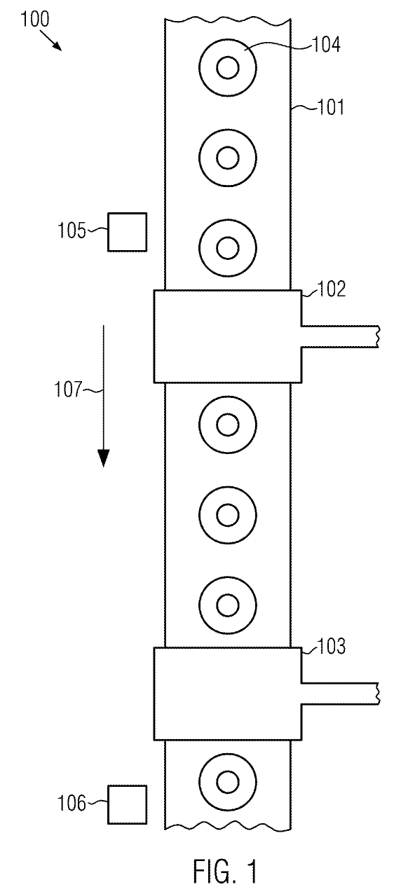

FIG. 1 shows a container treatment plant 100 according to one embodiment.

According to the invention, the container treatment plant 100 comprises a transport apparatus 101 for containers 104, two discharge units 102, 103 for discharging containers 104 from the transport apparatus 101 and at least one inspection apparatus 105.

According to the invention, a first discharge unit 103 of the two discharge units is configured for discharging containers that were treated using the container treatment plant 100 and that have a defect, and a second discharge unit 102 of the two discharge units is configured for discharging test containers that can be inserted into the container treatment plant 100 for checking the functionality of the inspection apparatus 105.

In the embodiment of FIG. 1, the transport apparatus 101 is configured as a linear transport apparatus and the first 103 and the second discharge unit 102 are arranged along the linear transport apparatus 101. This configuration is to be regarded as non-limiting. For example, it can also be provided that a plurality of linear transport apparatuses are arranged one behind the other and that the first discharge unit 103 is arranged on a first linear transport apparatus and the second discharge unit 102 is arranged on a second linear transport apparatus. Furthermore, the transport apparatus 101 can, for example, also be configured as at least one rotary machine. A transport apparatus 101, comprising at least one linear transport apparatus and at least one rotary machine, is also conceivable.

In embodiment 100 of FIG. 1, the first discharge unit 103 is arranged downstream of a second discharge unit 102 with respect to a transport direction 107 of the containers 104 along the transport apparatus 101. The arrangement of the first 103 and the second discharge unit 102 described above is to be understood as exemplary, so that it can also be provided, for example, that the first discharge unit 103 is arranged upstream of the second discharge unit 102.

The first discharge unit 103 can comprise a first discharge element that can be inserted at least temporarily into the transport apparatus 101 in order to discharge a container 104 treated using the container treatment plant 100 from the transport apparatus 101. The discharge element can, for example, be a pusher that can be inserted laterally into the transport apparatus 101 and can push a container 104 out of the transport apparatus 101 in a targeted manner. The pusher can, for example, comprise a drive apparatus and a push element, wherein the push element can be moved back and forth along a direction by the drive apparatus. The direction can, for example, be substantially perpendicular to the transport direction 107 of the containers 104. Substantially perpendicular can be understood to mean that the direction and the transport direction 107 enclose an angle between 80° and 100° with one another. Due to the application of force by the push element to a side surface of a container 104, the container 104 can be pushed out of the transport apparatus 101. The configuration of the first discharge unit 103 described above is to be understood as exemplary, so that the first discharge unit 103 can also be configured in any other way suitable for discharging a container.

It can be provided that the first discharge unit 103 comprises a first storage apparatus into which a defective container 104 treated by the container treatment plant 100 can be discharged by the pusher from the transport apparatus 101. The first storage apparatus can be configured for unordered or ordered storage of the defective containers. Due to the application of force by the push element on the containers during discharge, damage may occur to the discharged containers.

The second discharge unit 102 can comprise a second discharge element that can be inserted at least temporarily into the transport apparatus 101 in order to discharge a test container from the transport apparatus 101. The second discharge element can be moved between a rest position and a discharge position, wherein the second discharge element can be arranged next to the transport apparatus 101 in the rest position and can be inserted into the transport apparatus 101 in the discharge position. For example, it can be provided that when the second discharge element is located in the discharge position, a test container can be discharged from the transport apparatus 101 along the discharge element or by a momentum transferred from the discharge element to the test container.

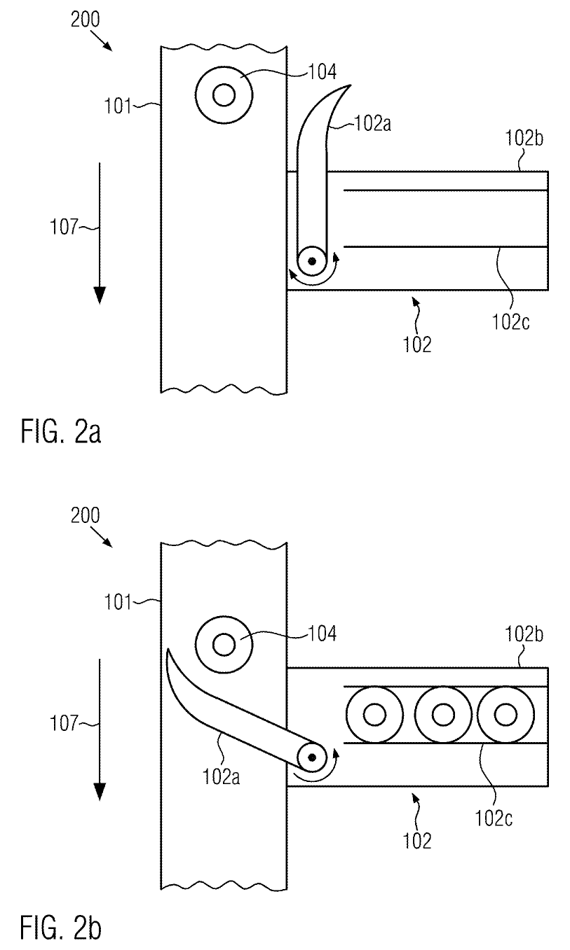

In order to achieve the discharge of the test container along the second discharge element located in the discharge position, it can be provided that the second discharge element is configured in a wedge-like manner, and that the second discharge element 102 can be moved from the rest position to the discharge position and from the discharge position to the rest position via an assigned drive apparatus. A second discharge element configured accordingly is described in more detail in connection with FIG. 2a and FIG. 2b.

Alternatively, as described above, it can also be provided that a test container can be discharged from the transport apparatus 101 by a momentum transferred from the second discharge element to the test container. In this case, it can be provided that the second discharge element is configured as a pusher, which can be inserted into the transport apparatus 101 from the side and can push the test container out of the transport apparatus 101 by a momentum transferred from the pusher to the test container. In contrast to the pusher described in connection with the first discharge unit 103, the pusher of the second discharge unit 102 can be configured in such a way that damage-free discharge of the test containers can be achieved. For example, the momentum transferred to the container by the pusher can be lower than a momentum transferred to a container by the pusher of the first discharge unit 103. Furthermore, it can be provided that the pusher of the second discharge unit 102 remains in contact with the container until the container has left the transport apparatus 101. In this way, for example, the tipping over of the container during discharge can be prevented. The pusher of the second discharge unit can also comprise a push element and a drive unit, wherein the push element can be moved with the drive unit along a direction that is substantially perpendicular to the transport direction 107.

The second discharge unit 102 can comprise a second storage apparatus in which test containers discharged using the second discharge unit 102 can be stored. The second storage apparatus can be configured for damage-free storage of the test containers. If the second discharge unit 102 is configured in a wedge-like manner as described above, it can be provided that the test containers can be fed along the wedge of the second storage apparatus, wherein the wedge and the second storage apparatus can be configured in such a way that the test container is not damaged during guiding and storage. For this purpose, the second storage apparatus can, for example, comprise a guide device using which the containers can be guided in the second storage apparatus after being transferred from the wedge to the second storage apparatus. The second storage apparatus can, for example, also comprise a transport unit by means of which the containers within the second storage apparatus can be transported to a destination in the second storage apparatus. In this way, for example, it can be prevented that the containers transferred from the wedge to the second storage apparatus are pushed against one another and damaged in the second storage apparatus.

When the second discharge unit 102 is configured as a pusher, the second discharge unit and the second storage apparatus can interact in such a way that the test container is not damaged despite the transfer of momentum during discharge by the pusher and can be directed in a targeted manner to the second storage apparatus. For example, the second discharge unit and the second storage apparatus can be configured in such a way that, despite the transfer of momentum from the second discharge unit to the container, the container can be prevented from tipping over and can be fed to the second storage apparatus in an orderly manner. For example, the second storage apparatus can comprise a guide device by means of which a container can be guided after being transferred through the second discharge unit and protected against tipping over. In accordance with the above statements in connection with the second discharge unit 102 configured in a wedge-like manner, the second storage apparatus can also comprise a transport unit for containers.

The inspection apparatus 105 can be configured for checking the containers 104 for defects. The defect can be understood, for example, to mean damage to the container itself and/or an incorrectly applied or damaged component on the container, such as a label, a printed image or a closure.

The inspection apparatus 105 can comprise at least one imaging sensor for checking the containers for defects, using which an image of the container 104 can be taken. The imaging sensor can be a camera, for example.

The inspection apparatus 105 can further comprise a computer unit comprising a processor and a memory unit, such as non-volatile memory, which is configured to recognize a defect of a container 104 in an image taken of the container 104 by the inspection apparatus 105. For this purpose, reference images of a large number of target containers can be stored in the storage unit. Target containers can be understood to mean containers that have no defects. The computer unit can be configured to compare the image taken of the container by the inspection apparatus 105 with the reference images and, based on the comparison, to determine whether or not the inspected container 104 has a defect. Furthermore, the computer unit can be trained to recognize whether container 104 is a container treated by the container treatment plant 100 or a test container. For example, test containers can comprise a marking that identifies the test containers as test containers and can be recognized by the inspection apparatus 105.

Furthermore, the inspection apparatus 105 can comprise at least one light source for irradiating a container 104 to be inspected. The light source can be configured to irradiate the container with light of a specific wavelength range. The wavelength range can be, for example, the visible wavelength range, the infrared wavelength range, the ultraviolet wavelength range, or a subrange of these ranges. The light source can also comprise more than one light source, so that the container 104 can also be irradiated with light from different wavelength ranges mentioned above. The imaging sensor described above can be configured to detect the light emitted by the light source, depending on the selected light source. If the light source is, for example, an infrared light source, then the imaging sensor can be an infrared sensor. If the light source is one that emits light in the visible range, then the imaging sensor can be a sensor that is configured to detect light in the visible range.

The imaging sensor and the light source can be arranged on opposite sides of the transport apparatus 101, such as to the left and right of the transport apparatus 101 or below and above the transport apparatus 101, so that light emitted by the light source onto the container 104 can be detected by the imaging sensor and an image of the container 104 can be generated.

If the inspection apparatus 105 comprises only an imaging sensor and no light source, the imaging sensor can, for example, be arranged next to the transport apparatus 101. In this case, the imaging sensor could, for example, be a sensor for detecting visible light. An arrangement above the transport apparatus 101 is also conceivable. If the transport apparatus 101 comprises a viewing window, the imaging sensor can also be arranged below the transport apparatus 101.

The inspection apparatus 105 can be in contact with the first discharge unit 103 and the second discharge unit 102 via a cable and/or wireless connection, so that the first 103 and the second discharge unit 102 can be controlled based on an inspection result obtained by the inspection apparatus 105 and defective treated containers and/or test containers can be discharged from the transport apparatus 101.

For example, it can be provided that the inspection apparatus 105 comprises a trigger device that, based on an inspection result obtained by the inspection apparatus 105, can control the first 103 or the second discharge unit 102, so that the first 103 or second discharge unit 102 can discharge a container or test container classified as defective by the inspection apparatus 105. In order to be able to control the correct discharge unit, the inspection apparatus 105, as described above, can be configured to recognize whether the inspected container is a test container or a container treated by the container treatment plant. The trigger device can, for example, determine when the inspected container will reach the first 103 or the second discharge unit 102 and trigger the discharge of the container through the first or second discharge unit accordingly.

For example, it can be provided that during normal operation of the container treatment plant, i.e. during operation in which containers are treated by the container treatment plant, individual test containers are inserted into the transport apparatus in order to check the functionality of the inspection apparatus 105. Since the inspection apparatus 105, as described above, can recognize whether an inspected container is a test container or a defective processed container, the first discharge unit 103 or the second discharge unit 102 can also be controlled during normal operation, in which test containers are occasionally inserted into the transport apparatus 101, and the discharge of test containers and defective processed containers can be achieved by the corresponding discharge unit 102, 103.

However, it can also be provided that no test containers are inserted into the transport apparatus 101 for checking the functionality of the inspection apparatus 105 during normal operation, and that only containers treated by the container treatment plant 100 are located on the transport apparatus 101 during normal operation. In order to check the functionality of the inspection apparatus 105, it may be possible to operate the container treatment plant 100 during a test operation. In the test operation, it can be provided that the container treatment plant 100 is initially run empty, so that there are no longer any containers 104 treated by the container treatment plant 100 located on the transport apparatus 101. Subsequently, a test container can be inserted into the transport apparatus 101 of the container treatment machine 100 for checking the functionality of the inspection apparatus 105. By providing a test operation in which no containers treated by the container treatment plant 100 are located on the transport apparatus 101 and at least one test container is inserted into the container treatment plant 100, the discharge of the test containers by the second discharge unit 102 can be simplified, since it is not necessary to distinguish between test containers and treated containers.

If it is provided that the container treatment plant 100 is operated during a test operation for checking the functionality of the inspection apparatus 105, then it can be provided that the first discharge unit 103 is not active in the test operation. This prevents a test container from being mistakenly discharged through the first discharge unit.

Accordingly, when the container treatment plant 100 is operating during normal operation, in which no test containers are inserted into the transport apparatus 101 of the container treatment plant 100, it can be provided that the second discharge unit 102 is not active. In this way, it can be prevented that defective containers treated by the container treatment plant 100 are mistakenly discharged through the second discharge unit 102.

Furthermore, by switching off the first discharge unit 103 during test operation and by switching off the second discharge unit 102 during normal operation, energy consumption can be reduced by switching off unneeded resources.

As shown in FIG. 1, the container treatment plant 100 can further comprise a discharge control apparatus 106. The discharge control apparatus 106 can be configured to check whether a container that was treated using the container treatment plant 100 and that has a defect has actually been discharged by the first discharge unit 103. The discharge control apparatus 106 can, for example, comprise a light barrier that is configured to detect a container 104 passing by the discharge control apparatus 106. The discharge control apparatus 106 can be connected to the inspection apparatus 105 and/or the first discharge unit 103 and, by communicating with the inspection apparatus 105 and/or the first discharge unit 103, determine at what point in time a defective container, if it is not discharged from the transport apparatus 101 by the first discharge unit 103, is passed by the discharge control apparatus 106. The discharge control apparatus 106 can then determine whether a container is being passed by the discharge control apparatus 106 at such point in time or not, and, based on this, determine whether or not the defective container has been discharged from the transport apparatus 101 by the first discharge unit 103. For example, if the discharge control apparatus 106 determines that a container classified as defective by the inspection apparatus 105 has not been discharged from the transport apparatus 101 by the first discharge unit 103, the discharge control apparatus 106 can issue a corresponding error message to a user or stop the operation of the container treatment plant 100.

A more specific embodiment of the second discharge unit 102 described in general in FIG. 1 is shown in connection with FIG. 2a and FIG. 2b, which show a partial region 200 of the container treatment plant 100 described in connection with FIG. 1. The embodiment of FIG. 2a and FIG. 2b can be combined with the embodiment of FIG. 1.

In the embodiment of FIG. 2a and FIG. 2b, the second discharge unit 102 comprises a wedge 102a that can be moved between a rest position and a discharge position. In the position shown in FIG. 2a, the wedge 102a is located in the rest position, while in the position shown in FIG. 2b, the wedge 102a is located in the discharge position. The wedge 102a can be moved between rest position and discharge position using a drive unit.

In the rest position of FIG. 2a, the wedge is located next to the transport apparatus 101, so that containers 104 conveyed by the transport apparatus 101 can pass the second discharge unit 102 unhindered.

In the discharge position of FIG. 2b, the wedge 102a is pivoted into the transport apparatus 101, so that a test container can be discharged from the transport apparatus 101 along the wedge.

As already described in detail in connection with FIG. 1, the second discharge unit can comprise a second storage apparatus 102b, in which the test containers discharged by the wedge 102a can be stored. The second storage apparatus 102b can, for example, be configured for damage-free storage of the test containers. In order to store the test containers in the second storage apparatus 102b without damage, the second discharge unit can, as already described in FIG. 1, comprise a guide unit by means of which the test containers can be transferred to the second storage unit without damage. Here, with respect to the guide unit, reference is made to the explanations given in connection with FIG. 1.

The second storage apparatus 102b can be configured for the orderly storage of test containers as shown in FIG. 2a and FIG. 2b. If orderly storage of the test containers is provided, then the second storage apparatus, as shown in FIG. 2a and FIG. 2b, can comprise a lane formed by two lateral delimiting units 102c, such as two guide rails or two guide plates, in which the test containers discharged by the second discharge unit 102 can be lined up and stored in a row. The configuration of the delimiting units 102c shown in FIG. 2a and FIG. 2b is to be understood as exemplary. These can also be configured, for example, to accommodate any other number of test containers. The second storage apparatus can further comprise a transport unit (not shown here), by means of which the test containers discharged from the second discharge unit 102 can be moved within the second storage apparatus. For example, the test containers can be transported to a destination in the second storage apparatus 102b using the transport unit. By providing the transport unit, it is possible to avoid the test containers being damaged by being pushed against one another.

The configuration of the second storage apparatus described above is to be regarded as exemplary and not as limiting. The second storage apparatus can also be configured in any other way suitable for storing test containers. For example, the second storage apparatus can also be configured for the unordered storage of test containers. If the storage unit is configured for the unordered storage of test containers, it can comprise a base plate onto which the test containers discharged from the transport apparatus by the wedge can be pushed. Here as well, a transport unit can be provided, by means of which the test containers can be distributed within the second storage apparatus in order to avoid damage to the test containers, such as that which can occur when test containers are pushed on top of one another.

We claim:

1. A container treatment plant comprising:
a transport apparatus for containers;
two discharge units for discharging dimensionally unstable containers from the transport apparatus; and
at least one inspection apparatus;
wherein a first discharge unit of the two discharge units is configured for discharging containers that were treated using the container treatment plant and that have a defect, and a second discharge unit of the two discharge units is configured for discharging test containers that can be inserted into the container treatment plant for checking the functionality of the inspection apparatus.

2. The container treatment plant according to claim 1, wherein the first discharge unit is not active during a test operation of the container treatment plant and/or wherein the second discharge unit is not active during a normal operation of the container treatment plant.

3. The container treatment plant according to claim 2, wherein the transport apparatus comprises a vacuum transport apparatus, wherein the vacuum transport apparatus is configured to apply a vacuum to the containers during normal operation and no vacuum during test operation.

4. The container treatment plant according to claim 1, comprising a discharge control apparatus, wherein the discharge control apparatus is configured to check whether a container that was treated using the container treatment plant and that has a defect has been discharged by the first discharge unit, wherein the second discharge unit is arranged upstream of the discharge control apparatus with respect to a transport direction of the containers and/or the test containers.

5. The container treatment plant according to claim 1, wherein the second discharge unit comprises a discharge element that can be moved between a rest position and a discharge position, wherein the discharge element can be arranged next to the transport apparatus in the rest position and can be inserted into the transport apparatus in the discharge position, wherein, in the discharge position, a test container can be discharged from the transport apparatus along the discharge element or by a momentum transferred from the discharge element to the test container.

6. The container treatment plant according to claim 5, wherein the second discharge unit comprises a test unit for checking the position of the discharge element.

7. The container treatment plant according to claim 1, wherein the first and/or the second discharge unit comprises a storage apparatus for storing the discharged containers and/or test containers, wherein the second discharge unit optionally comprises a storage apparatus for the damage-free, orderly storage of the discharged test containers.

8. The container treatment plant according to claim 1, wherein the container treatment plant is configured to be operated during a test operation, wherein, during test operation, the containers treated by the container treatment plant can be driven out of the container treatment plant and at least one test container can be inserted into the container treatment plant for checking the functionality of the inspection apparatus.

9. A method for checking the functionality of an inspection apparatus of a container treatment plant, the container treatment plant including a transport apparatus for containers, two discharge units for discharging dimensionally unstable containers from the transport apparatus and at least one inspection apparatus, the method comprising:
using a first discharge unit of the two discharge units, discharging, at least temporarily, containers that were treated using the container treatment plant and that have a defect; and
using a second discharge unit of the two discharge units, discharging test containers that are inserted, at least temporarily, into the container treatment plant for checking the functionality of the inspection apparatus.

10. The method according to claim 9, wherein the first discharge unit is not active during a test operation of the container treatment plant and/or wherein the second discharge unit is not active during a normal operation of the container treatment plant.

11. The method according to claim 10, wherein the transport apparatus comprises a vacuum transport apparatus, wherein the vacuum transport apparatus applies a vacuum to the containers during normal operation and no vacuum during test operation.

12. The method according to claim 9, wherein the container treatment plant comprises a discharge control apparatus, wherein the discharge control apparatus checks whether a container that was treated by the container treatment plant and that has a defect is discharged by the first discharge unit, wherein the second discharge unit is arranged upstream of the discharge control apparatus with respect to a transport direction of the containers and/or the test containers.

13. The method according to claim 9, wherein the second discharge unit comprises a discharge element that is moved at least temporarily between a rest position and a discharge position, wherein the discharge element is arranged next to the transport apparatus in the rest position and is inserted into the transport apparatus in the discharge position, wherein, in the discharge position, the test container is discharged from the transport apparatus along the discharge element or by a momentum transferred from the discharge element to the test container.

14. The method according to claim 13, wherein the second discharge unit comprises a test unit for checking a position of the discharge element.

15. The method according to claim 9, wherein the first and/or the second discharge unit comprises a storage apparatus for storing the discharged containers and/or test containers, wherein the second discharge unit optionally comprises a storage apparatus for the damage-free, orderly storage of the discharged test containers.
